(19) United States
(12) Patent Application Publication
(10) Pub. No.: US 2025/0285219 A1
(43) Pub. Date: Sep. 11, 2025

(54) SYSTEMS, METHODS, AND APPARATUS FOR MODIFYING IMAGES USING MACHINE LEARNING

(71) Applicant: Samsung Electronics Co., Ltd., Suwon-si (KR)

(72) Inventors: Collin ALLEN, San Francisco, CA (US); Patrick HAN, Sunnyvale, CA (US); Danny HUYNH, Milpitas, CA (US)

(21) Appl. No.: 19/059,247

(22) Filed: Feb. 20, 2025

Related U.S. Application Data
(60) Provisional application No. 63/563,293, filed on Mar. 8, 2024.

(51) Int. Cl. G06T 3/4046; G06T 3/4053; G06T 15/00

(52) U.S. Cl. CPC G06T 3/4046; G06T 3/4053; G06T 15/005

(57) ABSTRACT

A method may include generating first fragment information for an image, wherein the first fragment information has a first fragment resolution, rendering, using the first fragment information, the image, wherein the image has a first image resolution, generating second fragment information for the image, wherein the second fragment information has a second fragment resolution, and generating, using at least one machine learning model, using the image and the second fragment information, a transformed image, wherein the transformed image has a second image resolution.

### CROSS-REFERENCE TO RELATED APPLICATION

This application claims the priority benefit under 35 U.S.C. § 119 (e) of U.S. Provisional Patent Application Ser. No. 63/563,293, filed on Mar. 8, 2024, the disclosure of which is incorporated by reference in its entirety as if fully set forth herein.

### TECHNICAL FIELD

The disclosure generally relates to graphics processing. More particularly, the subject matter disclosed herein relates to improvements to systems, methods, and apparatus for modifying images using machine learning.

### SUMMARY

Super resolution techniques may enhance the perceptual quality of an image by upscaling the image (e.g., increasing the resolution by increasing the number and/or density of pixels in the image) and/or sharpening the image (e.g., by adding and/or reconstructing fine details). Some super resolution techniques may use a machine learning model to transform a lower resolution image to a higher resolution image.

One issue with the above approach is that a machine learning model may consume relatively large amounts of resources such as power, processing time, area on an integrated circuit, and/or the like. Moreover, some machine learning models may create temporal artifacts, fail to add and/or replicate fine details effectively (e.g., hallucinate information), struggle with temporal consistency, and/or the like. These issues may be especially problematic for mobile applications.

To overcome these issues, systems and methods are described herein for providing enhanced input information to a machine learning model used for image enhancement. For example, fragment information (e.g., information on depth, albedo, and/or the like, which may be stored in one or more G-buffers) may be used to generate a lower resolution image that may be applied as input to a machine learning model. Enhanced fragment information (e.g., fragment information that may be generated at a higher resolution than the fragment information used to generate the lower resolution image) may also be applied as input to the machine learning model which may use the enhanced fragment information to transform the lower resolution image to a higher resolution image.

The above approaches improve on previous methods because they may enable a machine learning model to generate an enhanced (e.g., higher resolution) image with more accurate fine detail. Additionally, or alternatively, the above approaches improve on previous methods because they may reduce the power consumption, processing time, complexity, cost, and/or the like, of a machine learning model used for image enhancement.

A method may include generating first fragment information for an image, wherein the first fragment information has a first fragment resolution, rendering, using the first fragment information, the image, wherein the image has a first image resolution, generating second fragment information for the image, wherein the second fragment information has a second fragment resolution, and generating, using at least one machine learning model, using the image and the second fragment information, a transformed image, wherein the transformed image has a second image resolution. The second fragment information may include at least one of depth information, albedo information, normal information, or specular information. The rendering may be performed at a shading rate corresponding to an image resolution that may be lower than the first image resolution. The image may be applied to a first portion of the machine learning model, and the second fragment information may be applied to a second portion of the machine learning model. The second portion of the machine learning model may process at least a portion of the second fragment information in parallel with the rendering. An output of the second portion of the machine learning model may have a lower dimensionality than the second fragment information. The second fragment information may include channel information, and the machine learning model may be configured to process a portion of the channel information. The machine learning model may be configured to process the second fragment information for a portion of the image. The machine learning model may be configured to process the second fragment information using sparse convolution.

A system may include a graphics processing pipeline configured to render, using first fragment information having a first fragment resolution, an image having a first image resolution, and a machine learning model configured to generate, using the image and second fragment information, a transformed image having a second image resolution, wherein the second fragment information has a second fragment resolution. The machine learning model may operate using the graphics processing pipeline. The machine learning model may operate using a shader in the graphics processing pipeline. The machine learning model may operate using a driver. The second fragment information may be generated using the graphics processing pipeline. The first fragment information may be generated using a first pass of the graphics processing pipeline, and the second fragment information may be generated using a second pass of the graphics processing pipeline. The second fragment information may be stored in a buffer. The machine learning model may include a first portion configured to process at least a portion of the second fragment information, and a second portion configured to generate, using the image and an output of the first portion, the transformed image.

A method may include generating fragment information for an image, wherein the image has a first resolution, and the fragment information has a second resolution, and generating, using at least one machine learning model, using the image and the fragment information, a transformed image. The generating the fragment information may be performed using a graphics processing pipeline. The machine learning model may operate using a graphics processing pipeline.

### BRIEF DESCRIPTION OF THE DRAWINGS

In the following section, the aspects of the subject matter disclosed herein will be described with reference to exemplary embodiments illustrated in the figures, in which:

FIG. 1 depicts a system 101 for enhancing an image using machine learning according to an embodiment.

FIG. 2 depicts an arrangement of pixels in an image having a relatively low resolution according to an embodiment.

FIG. 3 depicts an arrangement of pixels in an image having a relatively high resolution according to an embodiment.

FIG. 4 depicts an example embodiment of an image having a relatively high resolution but rendered at a relatively low shading rate according to an embodiment.

FIG. 5 depicts a scheme for enhancing an image using enhanced fragment information according to an embodiment.

FIG. 6 depicts a system for implementing an image enhancement scheme according to an embodiment.

FIG. 7 depicts a system for implementing an image enhancement scheme using a separate model and/or portion of a model to process fragment information according to an embodiment.

FIG. 8 depicts an example graphics processing pipeline for an image enhancement system using machine learning according to an embodiment,

FIG. 9 depicts an architecture for an image enhancement system using machine learning according to an embodiment.

FIG. 10 depicts a method for using machine learning for image enhancement implemented at least partially at an application and/or graphics engine level according to an embodiment.

FIG. 11 depicts a method for using machine learning for image enhancement implemented at least partially at a driver level according to an embodiment.

FIG. 12 is a block diagram of an electronic device in a network environment 1200, according to an embodiment.

FIG. 13 depicts a system including a UE 1305 and a gNB 1310, in communication with each other according to an embodiment.

FIG. 14 depicts an image display device 1404 into which any of the methods or apparatus described in this disclosure may be integrated.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“Render” or “rendering” as used herein refers to generating an image from input data such as geometry information for one or more 3D models. An example of “render” may include using a graphics processing pipeline to transform primitives, vertices, and/or the like, from a gaming application to one or more 2D images to display on a computer monitor.

Super resolution techniques may be used to transform low-resolution images to high-resolution images. Some super resolution techniques may employ artificial intelligence (AI) and/or machine learning (ML) which, for convenience, may be referred to collectively and/or individually as machine learning.

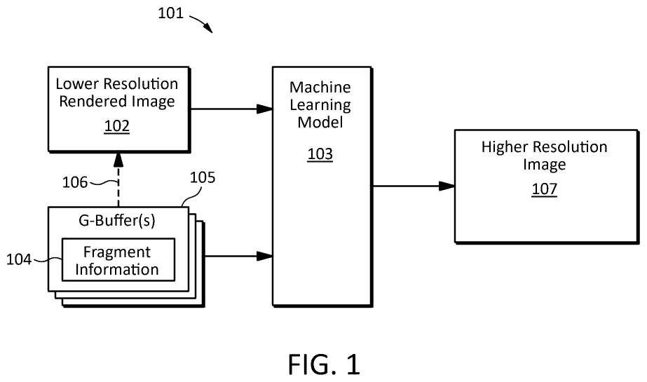

FIG. 1 depicts a system 101 for enhancing an image using machine learning according to an embodiment. A lower resolution image 102 may be applied as an input to a machine learning model 103 which may be implemented, for example, with a neural network. The lower resolution image 102 may be generated (e.g., rendered), for example, using fragment information 104 stored in one or more G-buffers 105 as shown by arrow 106. Examples of fragment information 104 may include depth information, albedo information, normal information, specular information, shadow information, and/or the like.

Fragment information 104 from one or more G-buffers 105 may also be applied as one or more inputs to the machine learning model 103 which may use the fragment information to transform the lower resolution image 102 to a higher resolution image 107. The machine learning model 103 may be trained, for example, using a representative dataset of low-resolution and high-resolution paired images, as well as one or more types of fragment information associated with (e.g., used to render) the low-resolution images.

At least a portion of the system 101 illustrated in FIG. 1 may be implemented with a graphics processing pipeline including one or more shaders (e.g., vertex shaders, geometry shaders, fragment shaders, etc.), rasterizers, buffers, and/or the like. For example, some or all of the fragment information 104 stored in the one or more G-buffers 105 may be generated using one or more first passes through some or all of a pipeline. The fragment information 104 stored in the one or more G-buffers 105 may then be fed back through some or all of the pipeline to render the lower resolution image 102 using one or more second passes of the pipeline.

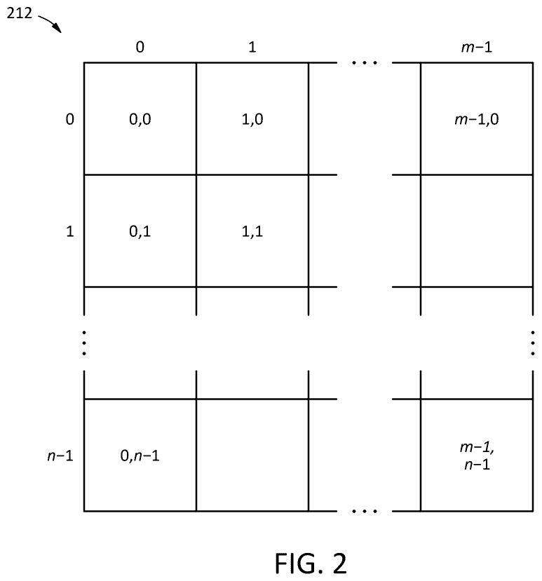

FIG. 2 depicts an arrangement of pixels in an image having a relatively low resolution according to an embodiment. The image 212 may include m×n pixels arranged in a rectangular array that is m pixels wide in the horizontal direction and n pixels high in the vertical direction. The location of each pixel may be indicated by a pair of indexes in which the first index indicates the horizontal location of the pixel (beginning with location 0 at the left of the image and continuing to location m−1 at the right) and the second index indicates the vertical location of the pixel (beginning with location 0 at the top of the image and continuing to location n−1 at the bottom).

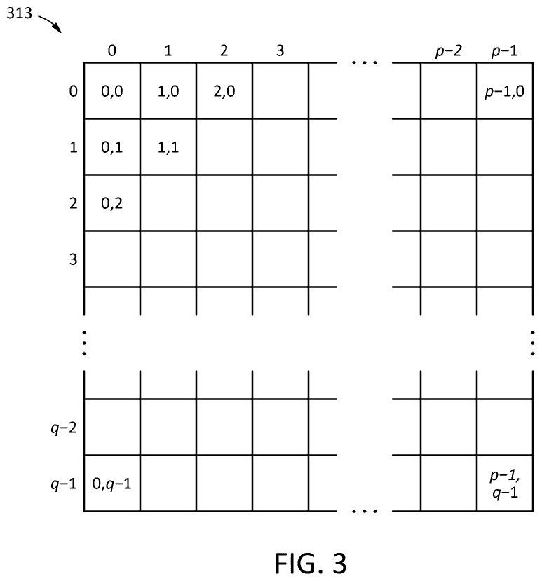

FIG. 3 depicts an arrangement of pixels in an image having a relatively high resolution according to an embodiment. The image 313 may include p×q pixels arranged in a rectangular array that is p pixels wide in the horizontal direction and q pixels high in the vertical direction. The location of each pixel may be indicated by a pair of indexes and having indexes 0 through p−1 in the horizontal direction and 0 through q−1 in the vertical direction.

The images 212 and 313 illustrated in FIGS. 2 and 3, respectively, are not necessarily shown to scale in any dimension. For purposes of illustrating an example embodiment, image 212 is drawn with a relatively large pixel size, and image 313 is drawn with a relatively small pixel size to conceptually illustrate that, if the two images 212 and 313 are displayed on display devices (e.g., screens) of approximately the same size, and m and/or n are greater than p and/or q, the relatively high resolution image 313 may appear to have a greater pixel density than the relatively low resolution image 212. However, whether the relatively high resolution image 313 has better perceptual quality (e.g., better high-frequency content) than the relatively low resolution image 212 may depend on one or more techniques used to generate the images (e.g., shading rate, upscaling techniques, and/or the like).

Although the images 212 and 313 illustrated in FIGS. 2 and 3 are not limited to any specific number of pixels in any dimension, for purposes of providing a convenient example, in some embodiments, the relatively low resolution image 212 may be implemented with a resolution of 960×540 pixels which, for a display having progressive (as opposed to interlaced) scanning, may be referred to as 540p resolution. Similarly, in some embodiments, the relatively high resolution image 313 may be implemented with a resolution of 1920×1080 pixels which, for a progressive scan display may be referred to as 1080p resolution. Thus, in some illustrative example embodiments, m=960, n=540, p=1920, and q=1080, and the higher resolution image 313 may have four times as many pixels as the lower resolution image 212.

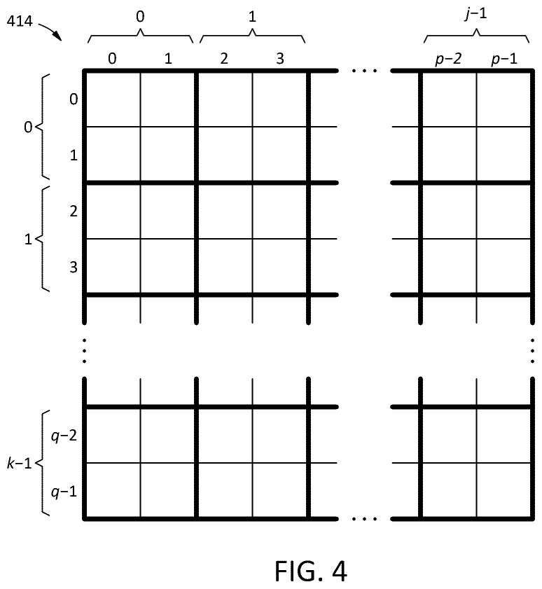

FIG. 4 depicts an example embodiment of an image having a relatively high resolution but rendered at a relatively low shading rate according to an embodiment. The image 414 may include p×q pixels arranged in a rectangular array that is p pixels wide in the horizontal direction and q pixels high in the vertical direction with locations indicated by indexes 0 through p−1 in the horizontal direction and 0 through q−1 in the vertical direction in a manner similar to the image 313 illustrated in FIG. 3. However, the image 414 illustrated in FIG. 4 may be rendered at a reduced 2×2 shading rate in all four pixels in a 2×2 group of pixels (which may be referred to as a quad) may be assigned the same value. Thus, the image 414 may include j×k quads of pixels arranged in a rectangular array that is j quads wide in the horizontal direction and k quads high in the vertical direction. Additionally, or alternatively, pixels may be grouped in any other arrangements such as 1×2, 2×1, 4×4, etc.

Depending on the implementation details, rendering the image 414 at a shading rate that is lower than the resolution may reduce the amount of processing required to render the image 414 (e.g., by a factor of four). However, this may also reduce the perceptual quality of the image 414 because, for example, the image 414 may have an effective resolution similar to that of the lower resolution image 212 illustrated in FIG. 2.

In some embodiments, and depending on the context, the image 414 illustrated in FIG. 4 may be described as having a rendered resolution, a rendering resolution, a shaded resolution, or an effective resolution of j×k. Additionally, or alternatively, in some embodiments, and depending on context, the image 414 may be described as having a target resolution or a native resolution of p×q. For example, the image 414 may be used as the lower resolution image 102 in the image enhancement system 101 illustrated in FIG. 1 such that the machine learning model 103 may transform the image 414 into a higher resolution image 107 (e.g., having a resolution of p×q) in which two or more pixels in a quad may be assigned two or more different values.

Therefore, in some embodiments, and depending on context, a machine learning model that may be described as increasing the resolution of an image may increase the perceptual quality of the image by modifying individual pixels within a quad (or other group of pixels) using added, recovered, or reconstructed detail (e.g., high-frequency content), even though the target resolution or native resolution of the image may not change. Thus, in an example implementation in which the image 414 illustrated in FIG. 4 is used as an input to the machine learning model 103 illustrated in FIG. 1, the machine learning model 103 may upscale the image 414 from a rendered resolution of j×k to a target resolution p×q.

Some super resolution techniques employ deep-learning (DL) machine learning that may use a deep neural network to transform a lower-resolution image to a higher resolution image with relatively high perceptual quality. In some DL-based super resolution techniques, an output of one or more previous frames (which, in some implementations, may be warped by motion vectors recorded during rendering for spatial alignment) may be provided as an additional input to a deep neural network. This may be referred to as temporal super sampling because it may implement a temporal loop that may allow the deep neural network to accumulate information about the scene over time. Some embodiments may include sampling subpixels with a particular jitter scheme such that neighboring frames collectively provide more information to the network. This type of approach may be referred to as super sampling due to this change in jitter scheme and/or because the network may perform anti-aliasing to improve image quality.

One factor that may affect the perceptual quality of an image is high-frequency content (e.g., fine detail). The presence of more, and/or more accurate, high-frequency content generally improves the perceptual quality of an image. Temporal super sampling based on deep-learning may achieve relatively high perceptual image quality by accumulating high-frequency information over multiple frames. However, temporal super sampling based on deep-learning may be prohibitively expensive (in terms of power consumption, memory, processing time, and/or the like) for some applications such as mobile devices. Moreover, in some implementations, temporal super sampling technique based on deep-learning may suffer from temporal artifacts.

Some DL-based super resolution techniques may use a deep neural network that may only or primarily use spatial techniques to upscale an image. For example, some DL-based single-image super-resolution (SISR) techniques may only process information for a single frame. This may reduce the cost (in terms of power consumption, memory, processing time, and/or the like) compared to temporal techniques and therefore, may enable spatial DL-based super resolution techniques to operate better in mobile applications. However, spatial DL-based super resolution techniques may not be able to add and/or replicate high-frequency content as well as temporal techniques. Moreover, spatial DL-based super resolution techniques may tend to hallucinate information and/or struggle with temporal consistency.

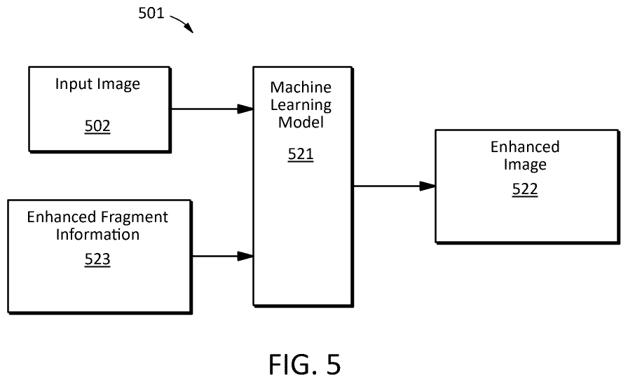

FIG. 5 depicts a scheme for enhancing an image using enhanced fragment information according to an embodiment. In the scheme 501, a machine learning model 521 may transform an input image 502 to an enhanced image 522 using enhanced fragment information 523. The enhanced fragment information 523 may include any fragment information that may be used by the machine learning model 521 to improve the perceptual quality of the enhanced image 522. Examples may include details (e.g., high-frequency content) in the form of depth information, albedo information, normal information, specular information, and/or the like, that may have a resolution (which may be referred to as a fragment resolution) that is higher than a resolution (which may be referred to as an image resolution) of the input image 502.

The enhanced image 522 may be enhanced relative to the input image 502, for example, by having a higher resolution than the input image 502 throughout at least a portion of the enhanced image 522. Additionally, or alternatively, the enhanced image 522 may be enhanced relative to the input image 502 by having more, and/or more accurate, detail (e.g., high-frequency content) than the input image 502.

The machine learning model 521 may be implemented with one or more of any types of apparatus for artificial intelligence (AI) and/or machine learning (ML) which may be referred to collectively and/or individually as machine learning. Examples may include neural networks such as deep neural networks (DNNs), recurrent neural networks (RNNs), and/or convolutional neural networks (CNNs), deep learning (which may be implemented using a DNN), linear regression, logistic regression, decision tree, linear discriminant analysis, naive Bayes, support vector machine, learning vector quantization, and/or the like, and/or multiples and/or combinations thereof. Thus, one or more machine learning models, and/or portions of one or more models, may be referred to collectively and/or individually, as a machine learning model.

Although the machine learning model 521 is not limited to any specific implementation, in some embodiments, the machine learning model 521 may be implemented with one or more neural networks having one or more layers of nodes that receive inputs to the neural network and/or inputs from other nodes in other layers that may be multiplied by weights that may be determined during training. Some nodes may generate outputs of the neural network and/or to other nodes in other layers. A node may generate an output, for example, by applying an activation function to a sum of inputs (e.g., weighted inputs) received at the node.

The machine learning model 521 may be trained, for example, using a representative dataset that may include pairs of images 502 and corresponding enhanced images 522. Additionally, or alternatively, a representative dataset used to train the machine learning model 521 may include enhanced fragment information 523 that may correspond to pairs of images 502 and enhanced images 522. A training operation may generate information that may be used by the machine learning model 521 for inferencing (e.g., transforming an input image 502 to an enhanced image 522), for example, weights for a neural network.

Referring again to FIG. 5, a method may include generating fragment information 523 for an image 502, wherein the image 502 has a first resolution, and the fragment information 523 has a second resolution; and generating, by at least one machine learning model 521, using the image 502 and the fragment information 523, a transformed image 522.

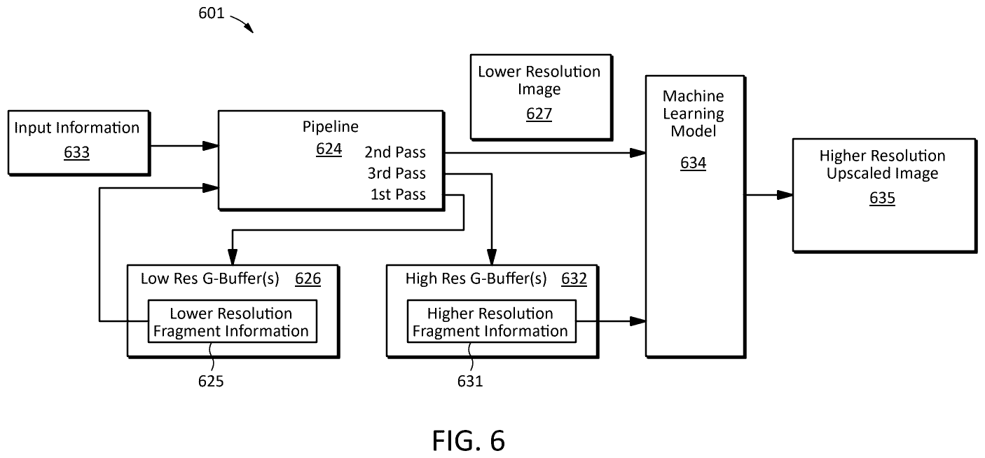

FIG. 6 depicts a system for implementing an image enhancement scheme according to an embodiment. The system 601 depicted in FIG. 6 may be used, for example, to implement the scheme 501 depicted in FIG. 5. For purposes of illustration, the system 601 may be described in the context of some specific implementation details such as image resolutions, types and/or amounts of information, numbers and/or sequences of pipeline passes, and/or the like. The inventive principles, however, are not limited to these or any other implementation details.

The system 601 may include a graphics processing pipeline 624 having one or more shaders (e.g., vertex shaders, geometry shaders, fragment shaders, etc.), rasterizers, buffers, and/or the like. The pipeline 624 may receive input information 633 that it may use in one or more first passes to generate lower resolution fragment information 625 such as depth information, albedo information, normal information, specular information, shadow information, and/or the like, which may be stored in one or more lower resolution G-buffers 626. Some or all of the lower resolution fragment information 625 may be fed back to the graphics processing pipeline 624 which may use the lower resolution fragment information 625 in one or more second passes to render a lower resolution image 627. The input information 633 may include, for example, geometry information such as descriptions of 3-dimensional (3D) objects in terms of vertices of primitives, triangles, points, lines, quad, and/or the like.

The graphics processing pipeline 624 may also generate higher resolution fragment information 631, for example, using input information 633 in one or more third passes. The higher resolution fragment information 631 may be stored in one or more higher resolution G-buffers 632. Although the G-buffers 626 and 632 are depicted as separate components, in some embodiments, they may be at least partially combined. For example, the lower resolution fragment information 625 may no longer be needed after the lower resolution image 627 is rendered during one or more second passes, and thus, some or all of the memory used to implement the lower resolution G-buffers 626 may be used to implement at least a portion of the higher resolution G-buffers 632 which may store higher resolution fragment information 631 after one or more third passes of the graphics processing pipeline 624.

The lower resolution image 627 and higher resolution fragment information 631 may be applied as inputs to a machine learning model 634 which may use the higher resolution fragment information 631 to transform the lower resolution image 627 to a higher resolution image 635. For example, during a third pass (e.g., a second depth pass), the graphics processing pipeline 624 may generate depth information (or other fragment information) at a resolution that is higher than the resolution of the lower resolution image 627 and/or the resolution of the depth information in the lower resolution fragment information 625. The higher resolution depth information may provide valuable high frequency detail that may enable the machine learning model 634 to generate the higher resolution image 635 with better perceptual quality.

Providing higher resolution fragment information 631 to a machine learning model 634 may enable the model to improve image quality while reducing power consumption, processing time, latency, model complexity and/or capacity (e.g., neural network capacity), and/or the like. This, in turn, may enable super resolution to be implemented on resource-constrained apparatus such as mobile devices, edge devices, and/or the like. Moreover, savings in power consumption, latency, and/or the like, in the machine learning model 634 may outweigh any increase in power consumption, latency, and/or the like, associated with generating the higher resolution fragment information 631.

In some embodiments, the higher resolution fragment information 631 may be selected, transformed, and/or the like, to improve the operation of the system 601. For example, one or more higher resolution G-buffers 632 may be capable of storing multiple types of higher resolution fragment information 631 such as depth information, albedo information, normal information, specular information, shadow information, and/or the like. To reduce the power consumption, processing time, latency, and/or the like, associated with generating and/or processing the higher resolution fragment information 631, the higher resolution fragment information 631 may be selectively implemented with less than all channels of a color space.

For example, some or all of the higher resolution fragment information 631 may be implemented in a YCbCr color space in which Y, Cb, and Cr are luma, blue-difference, and red-difference channels (e.g., components), respectively. Processing all three channels may be prohibitively expensive, but because the Y channel may carry most of the perceptual information, the system 601 may only generate Y channel information at a higher resolution and store it in one or more of the higher resolution G-buffers 632 (e.g., an albedo G-buffer). Depending on the implementation details, the machine learning model 634 may use the higher resolution Y channel information to transform the lower resolution image 627 to the higher resolution image 635 with only slightly less perceptual quality than using all three channels, but at a greatly reduced cost (in terms of power consumption, memory, processing time, and/or the like) compared to processing all three channels. In some embodiments, the system 601 may perform a color space transformation (or other type of transformation) to obtain higher resolution fragment information 631 in a color space (or other format) that may enable the machine learning model 634 to upscale the lower resolution image 627 with higher perceptual quality at a reduced cost.

In some embodiments, a machine learning model may be implemented in a manner that may improve the operation of an image enhancement (e.g., super resolution) scheme. For example, a machine learning model may be implemented with a separate (e.g., first) model and/or portion of a model that may be used to process (e.g., preprocess) fragment information for another (e.g., second) model and/or portion of a model. This may reduce the power consumption, processing time, complexity, cost, and/or the like, of a second machine learning model which, depending on the implementation details, may outweigh some or all power consumption, processing time, complexity, cost, and/or the like, associated with a first machine learning model.

Referring again to FIG. 6, a method for graphics processing may include generating first fragment information 625 for an image 627, wherein the first fragment information has a first fragment resolution; rendering (first pass), using the first fragment information 625, the image 627, wherein the image 627 has a first image resolution; generating (third pass) second fragment information 631 for the image, wherein the second fragment information 631 has a second fragment resolution; and generating, by at least one machine learning model 634, using the image 627 and the second fragment information 631, a transformed image 635, wherein the transformed image 635 has a second image resolution.

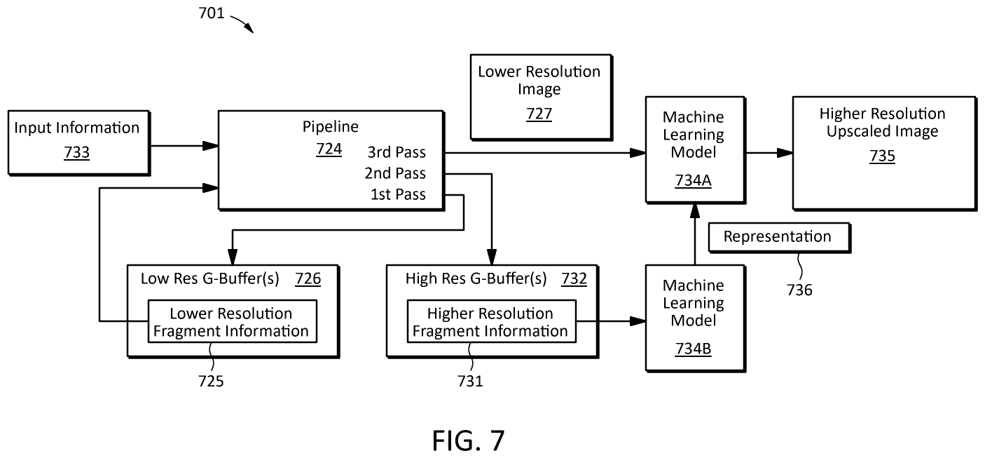

FIG. 7 depicts a system for implementing an image enhancement scheme using a separate model and/or portion of a model to process fragment information according to an embodiment. The system 701 depicted in FIG. 7 may be used, for example, to implement the scheme 501 depicted in FIG. 5. For purposes of illustration, the system 701 may be described in the context of some specific implementation details such as image resolutions, types and/or amounts of information, numbers and/or sequences of pipeline passes, and/or the like. The inventive principles, however, are not limited to these or any other implementation details.

The system 701 may include some components similar to those depicted in FIG. 6 in which similar elements may be indicated by reference numbers ending in, and/or containing, the same digits, letters, and/or the like. However, the system 701 may include two machine learning models 734A and 734B which may be referred to collectively as machine learning model 734. The machine learning models 734A and 734B may be implemented as separate models and/or as separate portions of a single model.

Machine learning model 734B (which may be referred to as an encoding model or portion of a model) may be configured to generate a representation 736 of the higher resolution fragment information 731 that may be applied as an input to machine learning model 734A (which may be referred to as an upscaling model or portion of a model), Depending on the implementation details, this may improve the overall operation of the system 701 when used to upscale the lower resolution image 727. For example, the machine learning model 734B may generate the representation 736 encoding some or all of the higher resolution fragment information 731 as a lower dimensional representation (e.g., a one-channel or two-channel representation) of the higher resolution fragment information 731. This may reduce the amount of information input to, and/or the amount of processing performed by, the upscaling machine learning model 734, thereby reducing power consumption, reducing processing time, reducing model complexity, improving image quality, and/or the like. Depending on the implementation details, reducing the dimensionality of the higher resolution fragment information 731 may have little or no effect on the perceptual quality of the higher resolution image 735 because, for example, the higher resolution fragment information 731 may have more information (e.g., high-frequency content) than may be needed to upscale the lower resolution image 727.

In the system 701 depicted in FIG. 7, the higher resolution fragment information 731 may be generated using one or more second passes of the pipeline 724, and the lower resolution image 727 may be rendered using one or more third passes of the pipeline 724. Depending on the implementation details, this may enable the encoding model 734B to generate the representation 736 while the pipeline 724 is rendering the lower resolution image 727, thereby reducing latency.

Additional techniques for improving the operation of a machine learning model in an image enhancement system may involve sparse processing in which higher resolution fragment information may be generated, processed, and/or the like, for less than an entire image. For example, in some embodiments of the systems 601 and 701 illustrated in FIGS. 6 and 7, respectively, one or more machine learning models may implement sparse convolution (e.g., spatially sparse convolution) in which portions of the lower resolution image that are more important for perceptual quality may be upscaled using higher resolution fragment information, whereas portions of the lower resolution image that are less important for perceptual quality not be upscaled or may be upscaled using fragment information that may have a lower resolution than the fragment information used for the more important portions of the image. Depending on the implementation details, this may reduce the power consumption, processing time, memory, complexity, cost, and/or the like, associated with upscaling an image.

In some embodiments, a sparse processing technique may use a buffer, mask, and/or the like, to enable a machine learning model to perform sparse processing (e.g., sparse convolution) on perceptually important parts of the image. For example, a sparse processing technique may use a buffer, mask, and/or the like, that may be similar to such a mechanism used for variable rate shading as described below.

Additional techniques for improving the operation of a machine learning model in an image enhancement system may involve combining one or more machine learning techniques with one or more additional techniques such as variable rate shading (VRS). Variable rate shading may improve the performance of a graphics processing system (e.g., a rendering pipeline or engine) by rendering relatively expensive passes (in terms of power consumption, memory, processing time, and/or the like) at reduced shading rates, thereby reducing the computational load of relatively expensive render passes. Variable rate shading techniques may reduce the shading rate in a variable fashion depending on image content such that pixel regions (which may be referred to as neighborhoods) with important details may be rendered at a higher shading rate, while other pixel regions with less detail may be rendered at a lower shading rate.

A variable rate shading system may generate and/or store (e.g., in one or more G-buffers) higher resolution fragment information for perceptually important portions of an image. A variable rate shading system may employ a mechanism such as an output buffer that may include identifiers (IDs) that indicate which shading rate each pixel (or regions of pixels) are shaded with. Thus, a variable rate shading system may employ a mask to mask out parts of an image that are not rendered at a higher shading rate. In some embodiments, a variable rate shading system may include an adjustable parameter that controls a sensitivity for lower shading rates based on image content.

In an image enhancement system that combines a machine learning model with variable rate shading according to an embodiment, lower resolution fragment information may be generated for an entire image and stored in one or more lower resolution G-buffers (e.g., G-buffers 626 in FIG. 6), whereas higher resolution fragment information may be generated for a perceptually important portions of the image and stored in one or more higher resolution G-buffers (e.g., G-buffers 632 in FIG. 6). The lower resolution fragment information may be used to generate a lower resolution image (e.g., image 627 in FIG. 6) which may be applied as an input to a machine learning model (e.g., model 634 in FIG. 6). The higher resolution fragment information may be applied as an input to the machine learning model which may use the higher resolution fragment information to upscale perceptually important portions of the lower resolution image to transform it into a higher resolution image (e.g., image 635 in FIG. 6). Additionally, or alternatively, one or more indicators of perceptually important portions of the image (e.g., an output buffer, mask, and/or the like) may be applied as input to the machine learning model to enable the model to direct more processing resources to the perceptually important portions of the image,

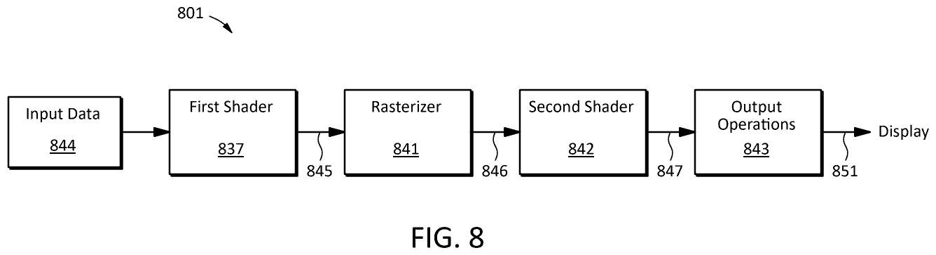

FIG. 8 depicts an example graphics processing pipeline for an image enhancement system using machine learning according to an embodiment. The pipeline 801, which may also be referred to as a rendering pipeline or a graphics rendering pipeline, may include a first shader 837, a rasterizer 841, a second shader 842, and/or an output operations unit 843.

The first shader 837, which may be implemented, for example, as a geometry shader, may receive input data 844 (e.g., 3D geometry information such as raw vertices, primitives, and/or the like) and output transformed data 845 (e.g., transformed geometry information such as transformed vertices, connected vertices, primitives, and/or the like) on one or more passes through the first shader 837. The first shader 837 may be implemented, for example, as a compute (e.g., programmable) shader that may run one or more shader programs.

The rasterizer 841 may convert the transformed data 845 into a set of fragments 846, each of which may be associated or aligned with a pixel of an image, and which may have one or more attributes such as position, albedo (e.g., color), normal, specular, and/or the like, which may eventually determine the rendering output of an associated or aligned pixel.

The second shader 842, which may be implemented, for example, as a fragment shader, may process the fragments 846 to assign each fragment one or more of a color value, depth value, stencil value, and/or the like, thereby generating processed fragments 847 on one or more passes through the second shader 842. The second shader 842 may be implemented, for example, as a compute (e.g., programmable) shader that may run one or more shader programs.

The output operations unit 843 may implement one or more functions such as frame buffering, merging, blending, testing (e.g., depth testing), and/or the like, by combining fragments of 3D primitives to generate pixels 851 for a 2D display.

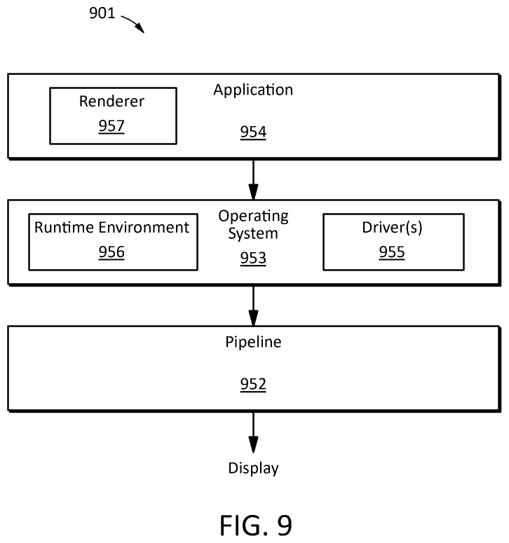

FIG. 9 depicts an architecture for an image enhancement system using machine learning according to an embodiment. The image enhancement system 901 may include a graphics processing pipeline 952, an operating system 953, and/or one or more applications 954.

The graphics processing pipeline 952 is not limited to any specific implementation. However, in some embodiments, it may be implemented with a pipeline similar to the graphics processing pipeline 801 depicted in FIG. 8. In some embodiments, the graphics processing pipeline 952 may be implemented with one or more graphics processing units (GPUs).

The operating system 953 may be implemented with Unix, Linux, BSD, Windows, macOS, IOS, Android, and/or the like. The operating system 953 may implement one or more runtime environments 956 that may parse commands, user calls, and/or the like received from an application 954 and pass the commands, user calls, and/or the like to one or more drivers 955 in the operating system 953. The one or more drivers 955 may be implemented with one or more user mode drivers, kernel mode drivers, and/or the like. A driver may generate commands and/or command buffers for the graphics processing pipeline 952 which may be processed by a kernel scheduler and/or passed to the graphics processing pipeline 952 which may execute the commands.

The one or more applications 954 may implement, for example, video games, video streaming, video editing, video conferencing, computer-aided design, and/or the like. Some applications 954 may include a renderer 957 that may generate draw calls which may be passed to the operating system 953 and/or driver(s) 955, for example, using an application programming interface (API). Although depicted as part of an application 954, in some embodiments, a renderer 957 may be implemented, at least partially, with an operating system 953, driver, 955, pipeline 952 (e.g., in a shader driver), and/or a combination thereof.

A machine learning model for an image enhancement system according to an embodiment may be implemented at least partially with a graphics processing pipeline such as pipelines 801 and/or 952 illustrated in FIGS. 8 and 9, respectively. For example, a machine learning model may be implemented, at least partially, with a shader (e.g., executing a shader program that may implement a machine learning model in one or more passes of a pipeline). in some embodiments, a machine learning model shader program may perform inferencing using weights that may be stored in a separate file read by the shader.

Additionally, or alternatively, a machine learning model for an image enhancement system according to an embodiment may be implemented at least partially with a driver such as the one or more drivers 955 illustrated in FIG. 9 and/or one or more shader drivers implemented in the graphics processing pipeline 952.

In some embodiments, one or more techniques for using a machine learning model for an image enhancement system according to an embodiment may be implemented with a renderer plugin. For example, a renderer plugin may use custom driver support for compute acceleration. This may enable specific, driver level support to accelerate a machine learning model and/or algorithm which, depending on the implementation details, may help the image enhancement system comply with one or more requirements for latency, power consumption, processing time, memory, and/or the like, especially on mobile devices.

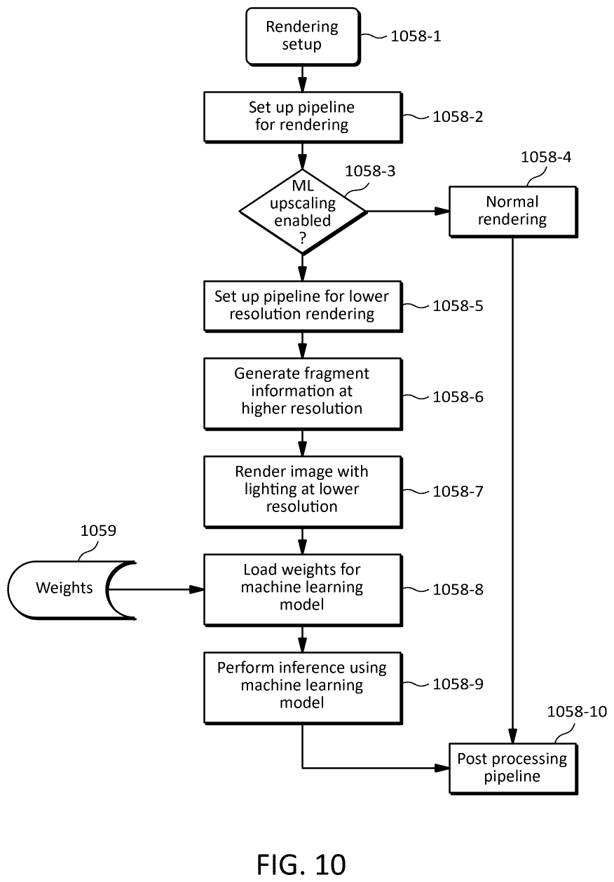

FIG. 10 depicts a method for using machine learning for image enhancement implemented at least partially at an application and/or graphics engine level according to an embodiment. The method depicted in FIG. 10 may be implemented with, and/or used to implement, any of the systems, apparatus, and/or the like disclosed herein.

The method may begin at operation 1058-1 in which an image enhancement system may be set up for rendering. For example, an application may configure a renderer, runtime environment, and/or the like, for one or more specific rendering tasks. At operation 1058-2, a graphics processing pipeline may be configured for rendering. For example, an application, runtime environment, and/or the like, may configure one or more shaders in the pipeline by loading one or more shader programs into one or more shaders. At operation 1058-3, the method may determine if machine learning based upscaling is enabled in the image enhancement system. If machine learning based upscaling is not enabled, the method may proceed to operation 1058-4 at which normal rendering may be performed, and then to operation 1058-10 to perform post processing (e.g., using a pipeline configured for post processing).

If, however, machine learning based upscaling is enabled, the method may proceed to operation 1058-5 at which the graphics processing pipeline may be configured for lower resolution rendering (e.g., at a 2×2 shading rate). At operation 1058-6 the graphics processing pipeline may be used to generate fragment information at a higher resolution (e.g., for use at a 1×1 shading rate). At operation 1058-7, the graphics processing pipeline may be used to render a lower resolution image with lighting at a lower resolution (e.g., a 2×2) shading rate.

At operation 1058-8, weights 1059 may be loaded into a neural network, for example from a file. At operation 1058-9, the neural network may perform inference using the lower resolution rendered image and the fragment information at the higher resolution as inputs, thereby transforming the lower resolution image to a higher resolution image. The method may then proceed to operation 1058-10 to perform post processing (e.g., using a pipeline configured for post processing).

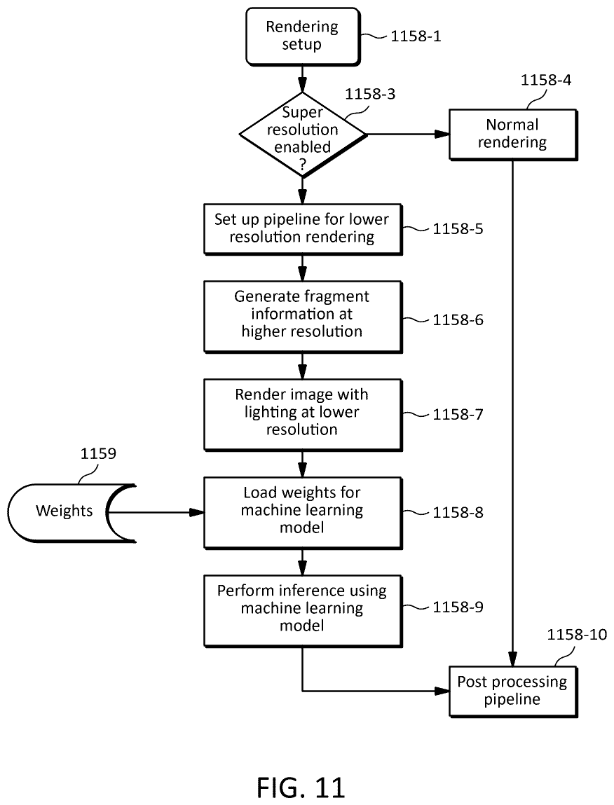

FIG. 11 depicts a method for using machine learning for image enhancement implemented at least partially at a driver level according to an embodiment. The method depicted in FIG. 11 may be implemented with, and/or used to implement, any of the systems, apparatus, and/or the like disclosed herein.

The method may begin at operation 1158-1 in which an image enhancement system may be set up for rendering. For example, an application may configure a renderer, runtime environment, and/or the like, for one or more specific rendering tasks. At operation 1158-3, the method may determine if super resolution is enabled in the image enhancement system. If super resolution is not enabled, the method may proceed to operation 1158-4 at which normal rendering may be performed, and then to operation 1158-10 to perform post processing (e.g., using a pipeline configured for post processing).

If, however, super resolution is enabled, the method may proceed to operation 1158-5 at which the graphics processing pipeline may be configured for lower resolution rendering (e.g., at a 2×2 shading rate). At operation 1158-6 the graphics processing pipeline may be used to generate fragment information at a higher resolution (e.g., for use at a 1×1 shading rate). At operation 1158-7, the graphics processing pipeline may be used to render a lower resolution image with lighting at a lower resolution (e.g., a 2×2) shading rate.

At operation 1158-8, weights 1159 may be loaded into a neural network, for example from a file. At operation 1158-9, the neural network may perform inference using the lower resolution rendered image and the fragment information at the higher resolution as inputs, thereby transforming the lower resolution image to a higher resolution image. The method may then proceed to operation 1158-10 to perform post processing (e.g., using a pipeline configured for post processing).

Some embodiments have been described in the context of super resolution techniques. However, the inventive principles of this patent disclosure may be applied in other contexts where they may be used to enhance the quality, efficiency, and/or the like of other machine learning assisted rendering tasks such as neural denoising and/or other image transformation tasks. For example, some or all of the image enhancement techniques using machine learning as disclosed herein may be used to perform denoising and upsampling at the same time, or any other tasks that may involve additional high resolution albedo information. Additionally, or alternatively, some or all of the image enhancement techniques using machine learning as disclosed herein may be used to improve image quality at reduced performance by rendering G-buffers at a higher resolution than what will be displayed, thus providing additional high frequency information for rendering.

In some additional embodiments, a method for graphics processing may include obtaining at least one input image including a plurality of pixels, determining shading information for each of the plurality of pixels in the at least one input image based on machine learning, and determining a shading map based on the determined shading information for each of the plurality of pixels in the at least one input image, wherein the machine learning makes decisions based on predicted quality of at least one output image and computational power to render the at least one output image. In some embodiments, the quality of the at least one output image may be enhanced based on machine learning.

In some aspects, to resolve one or more quality degradations, such as aliasing, the present disclosure may add a post-processing block and/or enhancer after the output image is rendered. In some aspects, the post-processing block or enhancer may be a machine learning unit or DNN. Additionally, or alternatively, the post-processing block and/or enhancer may be used to address any number of issues, such as anti-aliasing, quality enhancement, and/or super resolution.

In some additional embodiments, a method may include generating first fragment information for an image at a first fragment resolution, rendering, using the first fragment information, the image at a first image resolution, generating second fragment information for the image at a second fragment resolution, and transforming, by at least one machine learning model, using the second fragment information, the image to a second image resolution.

In some additional embodiments, a method may include generating fragment information for an image, wherein the image has a first resolution, and the fragment information has a second resolution, and generating, by at least one machine learning model, using the image and the fragment information, a transformed image.

In some additional embodiments, a method may include generating fragment information for an image, rendering, using the fragment information, the image, generating enhanced fragment information for the image, and generating, by at least one machine learning model, using the image and the enhanced fragment information, an enhanced image.

In some additional embodiments, a system may include a graphics processing pipeline configured to render an image, wherein the image has a first resolution, and a machine learning model configured to generate, using the image and fragment information, a transformed image, wherein the fragment information has a second resolution.

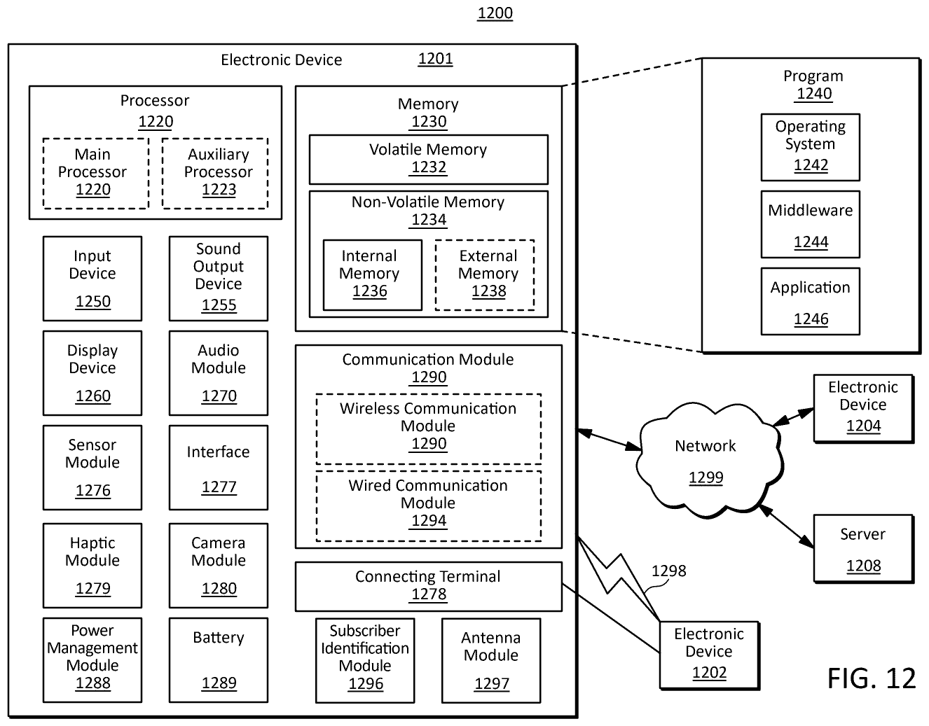

FIG. 12 is a block diagram of an electronic device in a network environment 1200, according to an embodiment. The embodiment depicted in FIG. 12 may be used to implement, or may be implemented with, any of the machine learning based image enhancement techniques disclosed herein. For example, any of the systems, methods, techniques, and/or the like, described with reference to FIGS. 1-11 may be used to implement the display device 1260.

Referring to FIG. 12, an electronic device 1201 in a network environment 1200 may communicate with an electronic device 1202 via a first network 1298 (e.g., a short-range wireless communication network), or an electronic device 1204 or a server 1208 via a second network 1299 (e.g., a long-range wireless communication network). The electronic device 1201 may communicate with the electronic device 1204 via the server 1208. The electronic device 1201 may include a processor 1220, a memory 1230, an input device 1250, a sound output device 1255, a display device 1260, an audio module 1270, a sensor module 1276, an interface 1277, a haptic module 1279, a camera module 1280, a power management module 1288, a battery 1289, a communication module 1290, a subscriber identification module (SIM) card 1296, or an antenna module 1297. In one embodiment, at least one (e.g., the display device 1260 or the camera module 1280) of the components may be omitted from the electronic device 1201, or one or more other components may be added to the electronic device 1201. Some of the components may be implemented as a single integrated circuit (IC). For example, the sensor module 1276 (e.g., a fingerprint sensor, an iris sensor, or an illuminance sensor) may be embedded in the display device 1260 (e.g., a display).

The processor 1220 may execute software (e.g., a program 1240) to control at least one other component (e.g., a hardware or a software component) of the electronic device 1201 coupled with the processor 1220 and may perform various data processing or computations.

As at least part of the data processing or computations, the processor 1220 may load a command or data received from another component (e.g., the sensor module 1276 or the communication module 1290) in volatile memory 1232, process the command or the data stored in the volatile memory 1232, and store resulting data in non-volatile memory 1234. The processor 1220 may include a main processor 1221 (e.g., a central processing unit (CPU) or an application processor (AP)), and an auxiliary processor 1223 (e.g., a graphics processing unit (GPU), an image signal processor (ISP), a sensor hub processor, or a communication processor (CP)) that is operable independently from, or in conjunction with, the main processor 1221, Additionally or alternatively, the auxiliary processor 1223 may be adapted to consume less power than the main processor 1221, or execute a particular function. The auxiliary processor 1223 may be implemented as being separate from, or a part of, the main processor 1221.

The auxiliary processor 1223 may control at least some of the functions or states related to at least one component (e.g., the display device 1260, the sensor module 1276, or the communication module 1290) among the components of the electronic device 1201, instead of the main processor 1221 while the main processor 1221 is in an inactive (e.g., sleep) state, or together with the main processor 1221 while the main processor 1221 is in an active state (e.g., executing an application). The auxiliary processor 1223 (e.g., an image signal processor or a communication processor) may be implemented as part of another component (e.g., the camera module 1280 or the communication module 1290) functionally related to the auxiliary processor 1223.

The memory 1230 may store various data used by at least one component (e.g., the processor 1220 or the sensor module 1276) of the electronic device 1201. The various data may include, for example, software (e.g., the program 1240) and input data or output data for a command related thereto. The memory 1230 may include the volatile memory 1232 or the non-volatile memory 1234. Non-volatile memory 1234 may include internal memory 1236 and/or external memory 1238.

The program 1240 may be stored in the memory 1230 as software, and may include, for example, an operating system (OS) 1242, middleware 1244, or an application 1246.

The input device 1250 may receive a command or data to be used by another component (e.g., the processor 1220) of the electronic device 1201, from the outside (e.g., a user) of the electronic device 1201. The input device 1250 may include, for example, a microphone, a mouse, or a keyboard.

The sound output device 1255 may output sound signals to the outside of the electronic device 1201. The sound output device 1255 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1260 may visually provide information to the outside (e.g., a user) of the electronic device 1201. The display device 1260 may include, for example, a display, a hologram device, or a projector and control circuitry to control a corresponding one of the display, hologram device, and projector. The display device 1260 may include touch circuitry adapted to detect a touch, or sensor circuitry (e.g., a pressure sensor) adapted to measure the intensity of force incurred by the touch.

The audio module 1270 may convert a sound into an electrical signal and vice versa. The audio module 1270 may obtain the sound via the input device 1250 or output the sound via the sound output device 1255 or a headphone of an external electronic device 1202 directly (e.g., wired) or wirelessly coupled with the electronic device 1201.

The sensor module 1276 may detect an operational state (e.g., power or temperature) of the electronic device 1201 or an environmental state (e.g., a state of a user) external to the electronic device 1201, and then generate an electrical signal or data value corresponding to the detected state. The sensor module 1276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1277 may support one or more specified protocols to be used for the electronic device 1201 to be coupled with the external electronic device 1202 directly (e.g., wired) or wirelessly. The interface 1277 may include, for example, a high-definition multimedia interface (HDMI), a universal serial bus (USB) interface, a secure digital (SD) card interface, or an audio interface.

A connecting terminal 1278 may include a connector via which the electronic device 1201 may be physically connected with the external electronic device 1202. The connecting terminal 1278 may include, for example, an HDMI connector, a USB connector, an SD card connector, or an audio connector (e.g., a headphone connector).

The haptic module 1279 may convert an electrical signal into a mechanical stimulus (e.g., a vibration or a movement) or an electrical stimulus which may be recognized by a user via tactile sensation or kinesthetic sensation. The haptic module 1279 may include, for example, a motor, a piezoelectric element, or an electrical stimulator.

The camera module 1280 may capture a still image or moving images. The camera module 1280 may include one or more lenses, image sensors, image signal processors, or flashes. The power management module 1288 may manage power supplied to the electronic device 1201. The power management module 1288 may be implemented as at least part of, for example, a power management integrated circuit (PMIC).

The battery 1289 may supply power to at least one component of the electronic device 1201. The battery 1289 may include, for example, a primary cell which is not rechargeable, a secondary cell which is rechargeable, or a fuel cell.

The communication module 1290 may support establishing a direct (e.g., wired) communication channel or a wireless communication channel between the electronic device 1201 and the external electronic device (e.g., the electronic device 1202, the electronic device 1204, or the server 1208) and performing communication via the established communication channel. The communication module 1290 may include one or more communication processors that are operable independently from the processor 1220 (e.g., the AP) and supports a direct (e.g., wired) communication or a wireless communication. The communication module 1290 may include a wireless communication module 1292 (e.g., a cellular communication module, a short-range wireless communication module, or a global navigation satellite system (GNSS) communication module) or a wired communication module 1294 (e.g., a local area network (LAN) communication module or a power line communication (PLC) module). A corresponding one of these communication modules may communicate with the external electronic device via the first network 1298 (e.g., a short-range communication network, such as BLUETOOTH™, wireless-fidelity (Wi-Fi) direct, or a standard of the Infrared Data Association (IrDA)) or the second network 1299 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1292 may identify and authenticate the electronic device 1201 in a communication network, such as the first network 1298 or the second network 1299, using subscriber information (e.g., international mobile subscriber identity (IMSI)) stored in the subscriber identification module 1296.

The antenna module 1297 may transmit or receive a signal or power to or from the outside (e.g., the external electronic device) of the electronic device 1201. The antenna module 1297 may include one or more antennas, and, therefrom, at least one antenna appropriate for a communication scheme used in the communication network, such as the first network 1298 or the second network 1299, may be selected, for example, by the communication module 1290 (e.g., the wireless communication module 1292). The signal or the power may then be transmitted or received between the communication module 1290 and the external electronic device via the selected at least one antenna.

Commands or data may be transmitted or received between the electronic device 1201 and the external electronic device 1204 via the server 1208 coupled with the second network 1299. Each of the electronic devices 1202 and 1204 may be a device of a same type as, or a different type, from the electronic device 1201. All or some of operations to be executed at the electronic device 1201 may be executed at one or more of the external electronic devices 1202, 1204, or 1208. For example, if the electronic device 1201 should perform a function or a service automatically, or in response to a request from a user or another device, the electronic device 1201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1201. The electronic device 1201 may provide the outcome, with or without further processing of the outcome, as at least part of a reply to the request. To that end, a cloud computing, distributed computing, or client-server computing technology may be used, for example.

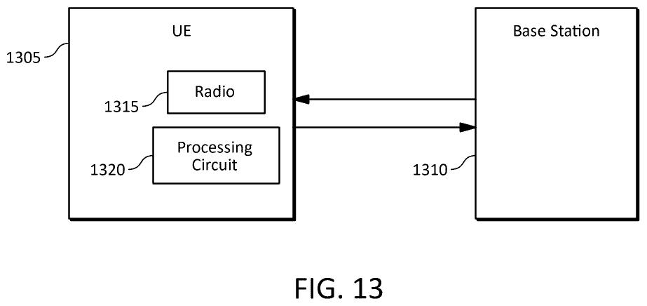

FIG. 13 depicts a system including a UE 1305 and a gNB 1310, in communication with each other. Any of the systems, methods, techniques, and/or the like, described with reference to FIGS. 1-11 may be used to implement a display, for example, for the UE 1305.

Referring to FIG. 13, the UE may include a radio 1315 and a processing circuit (or a means for processing) 1320, which may perform various methods disclosed herein, e.g., the method illustrated in FIG. 1. For example, the processing circuit 1320 may receive, via the radio 1315, transmissions from the network node (gNB) 1310, and the processing circuit 1320 may transmit, via the radio 1315, signals to the gNB 1310.

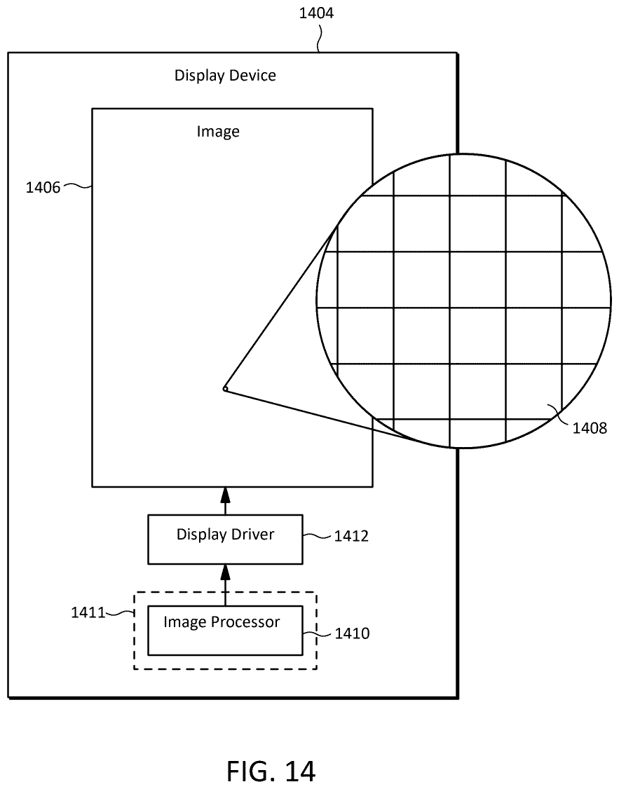

FIG. 14 depicts an image display device 1404 into which any of the methods or apparatus described in this disclosure may be integrated. The display device 1404 may have any form factor such as a panel display for a PC, laptop, mobile device, etc., a projector, VR goggles, etc., and may be based on any imaging technology such as cathode ray tube (CRT), digital light projector (DLP), light emitting diode (LED), liquid crystal display (LCD), organic LED (OLED), quantum dot, etc., for displaying a rasterized image 1406 with pixels. An image processor 1410 such as a graphics processing unit (GPU) and/or driver circuit 1412 may process and/or convert the image to a form that may be displayed on or through the imaging device 1404. A portion of the image 1406 is shown enlarged so pixels 1408 are visible. Any of the methods or apparatus described in this disclosure may be integrated into the display device 1404, image processor 1410, and/or display driver circuit 1412 to generate pixels 1408 shown in FIG. 14, and/or groups thereof. In some embodiments, the image processor 1410 may include a pipeline that may implement super resolution, upscaling, and/or the like, using machine learning operations and/or any of the other inventive principles described herein, implemented, for example, on an integrated circuit 1411. In some embodiments, the integrated circuit 1411 may also include the driver circuit 1412 and/or any other components that may implement any other functionality of the display device 1404.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts and the inventive principles of this patent disclosure described herein may be modified and varied over a wide range of applications. Accordingly, the scope of claimed subject matter should not be limited to any of the specific exemplary teachings discussed above, but is instead defined by the following claims.

1. A method comprising:
generating first fragment information for an image, wherein the first fragment information has a first fragment resolution;
rendering, using the first fragment information, the image, wherein the image has a first image resolution;
generating second fragment information for the image, wherein the second fragment information has a second fragment resolution; and
generating, using at least one machine learning model, using the image and the second fragment information, a transformed image, wherein the transformed image has a second image resolution.

2. The method of claim 1, wherein the second fragment information comprises at least one of depth information, albedo information, normal information, or specular information.

3. The method of claim 1, wherein the rendering is performed at a shading rate corresponding to an image resolution that is lower than the first image resolution.

4. The method of claim 1, wherein:
the image is applied to a first portion of the machine learning model; and
the second fragment information is applied to a second portion of the machine learning model.

5. The method of claim 4, wherein the second portion of the machine learning model processes at least a portion of the second fragment information in parallel with the rendering.

6. The method of claim 4, wherein an output of the second portion of the machine learning model has a lower dimensionality than the second fragment information.

7. The method of claim 1, wherein:
the second fragment information comprises channel information; and
the machine learning model is configured to process a portion of the channel information.

8. The method of claim 1, wherein the machine learning model is configured to process the second fragment information for a portion of the image.

9. The method of claim 8, wherein the machine learning model is configured to process the second fragment information using sparse convolution.

10. A system comprising:
a graphics processing pipeline configured to render, using first fragment information having a first fragment resolution, an image having a first image resolution; and
a machine learning model configured to generate, using the image and second fragment information, a transformed image having a second image resolution;
wherein the second fragment information has a second fragment resolution.

11. The system of claim 10, wherein the machine learning model operates using the graphics processing pipeline.

12. The system of claim 11, wherein the machine learning model operates using a shader in the graphics processing pipeline.

13. The system of claim 10, wherein the machine learning model operates using a driver.

14. The system of claim 10, wherein the second fragment information is generated using the graphics processing pipeline.

15. The system of claim 14, wherein:
the first fragment information is generated using a first pass of the graphics processing pipeline; and
the second fragment information is generated using a second pass of the graphics processing pipeline.

16. The system of claim 10, wherein the second fragment information is stored in a buffer.

17. The system of claim 10, wherein the machine learning model comprises:
a first portion configured to process at least a portion of the second fragment information; and
a second portion configured to generate, using the image and an output of the first portion, the transformed image.

18. A method comprising:
generating fragment information for an image, wherein the image has a first resolution, and the fragment information has a second resolution; and
generating, using at least one machine learning model, using the image and the fragment information, a transformed image.

19. The method of claim 18, wherein the generating the fragment information is performed using a graphics processing pipeline.

20. The method of claim 18, wherein the machine learning model operates using a graphics processing pipeline.
